(19) United States
(12) Patent Application Publication
(10) Pub. No.: US 2021/0179468 A1
(43) Pub. Date: Jun. 17, 2021

(54) SYSTEM AND METHOD FOR PURIFYING FAECAL-FREE AND SURFACTANT-CONTAINING DOMESTIC WASTEWATER

(71) Applicant: IP AG, Feldmeilen (CH)

(72) Inventor: Franz Fastner, Rain-Etting (DE)

(73) Assignee: IP AG, Feldmeilen (CH)

(21) Appl. No.: 17/268,446

(22) PCT Filed: Aug. 12, 2019
(86) PCT No.: PCT/EP2019/071599

§ 371 Date: Feb. 12, 2021

(30) Foreign Application Priority Data
Aug. 14, 2018 (DE) 10 2018 119 743.8

(51) Int. Cl. C02F 9/00; C02F 1/28; C02F 1/465; C02F 1/467; C02F 1/78; C02F 1/44

(52) U.S. Cl. CPC C02F 9/005; C02F 1/283; C02F 1/465; C02F 2101/301; C02F 1/78; C02F 1/444; C02F 1/4672

(57) ABSTRACT

The invention relates to a system and to a method for purifying faecal-free and surfactant-containing domestic wastewater, in particular grey water and kitchen wastewater. An electrochemical treatment unit (3) and a device for introducing gas (11, 12, 14) are provided. Furthermore, at least two dirty water tanks (1, 21) are present, wherein domestic wastewater to be purified is fed to the first dirty water tank (21) from at least one first consumer, and wherein domestic wastewater to be purified is fed to the second dirty water tank (1) from at least one second consumer. In addition, at least two clear water tanks are present, wherein the purified domestic wastewater originating from the first dirty water tank is fed to the first clear water tank (22), and wherein the purified domestic wastewater originating from the second dirty water tank is fed to the second clear water tank (6).

The present invention relates to a system and a method for purifying fecal-free and surfactant-containing domestic wastewater comprising an electrochemical processing stage.

### TECHNICAL FIELD

In the case of wastewater from the domestic sector, it would generally be desirable if it were at least partially possible to recycle the resulting wastewater, i.e. to purify it and to feed it to a renewed use. This would be particularly important, however, for mobile sanitary systems, such as, for example, in campers, mobile homes, on boats and ships, as well as in aircrafts. In the case of these, the amount of fresh water, which is to be carried along, could be drastically reduced, if it were possible to treat at least a portion of the generated wastewater such that it can be reused at least in individual regions of the sanitary systems.

### PRIOR ART

Various approaches for this are known in the prior art. However, the opinion is generally prevalent that only fecal-free wastewater can be purified with reasonable effort and can thus be recycled. The so-called black water—wastewater from the toilet containing fecal matter—is thus typically considered to be waste. The same generally applies for wastewater from the sink and the dishwasher, but for a different reason. The grease accumulating when doing the dishes often cause problems when purifying. The so-called grey water, however, which originates from showers, bathtubs, hand washbasins, and washing machines, would be ideally suited for the treatment and reuse in light of the dirt load as well as in consideration of the fact that such wastewater is typically neither particularly greasy, nor is it loaded with bacteria or viruses. The below-mentioned documents in the prior art therefore deal predominantly with grey water recycling.

Various filter stages connected in series are used, for example, in US 2017/0297939 A1, in CN 105 421 527 A, and also in EP 2 295 649 A2. The latter also proposes biological water purification methods.

DE 10 2005 006 136 A1 discloses a grey water utilization system for an aircraft. Grey water accumulating in the hand washbasin is thereby treated to such an extent that it can be utilized for flushing the toilet in the aircraft. An electro-flotation stage is proposed for purifying the grey water. WO 2008/120963 A1 proposes a mechanical floatation stage for separating contaminants in grey water. Here, polymers are added in the form of flocks and are removed, after they are soaked with dirt particles.

In the case of the present invention, the development of a recycling system for campers was paramount. The camper market has greatly increased in recent years. Customers appreciate the freedom offered by a camper under various aspects. What also delights is in particular the freedom that the camper can also be parked once independently of camper sites or campgrounds and that, for example, one can stay for one night. However, it is important for this that sufficient water can be brought along in order to be able to perform the necessary bodily functions, i.e. to use the toilet, to take a shower, to wash, and optionally also to do the dishes. To reduce the fresh water consumption and thus the amount of fresh water to be brought along in a camper, it would thus be desirable if resulting wastewater could be purified for renewed use. As already described above, toilet wastewater cannot be used to recycle wastewater, and wastewater from doing dishes can only be used to a limited extent. It would be extremely desirable, however, if, for example, resulting shower water could be purified and treated, so that it could be used as shower water again. In addition, this would make it possible that one could also shower for a relatively long time, for example also for 10 minutes, in a camper, without depleting the water.

However, when implementing the known methods and systems, it became apparent that the surfactants, which are contained in the shower water, from the shampoo and from the soap, which is used for washing, caused problems during the treatment. If the purified water is only used again for flushing the toilet, as in the case of DE 10 2005 006 136 A1, it is irrelevant whether surfactant residues are still contained and the flushing water thus foams slightly. When taking a shower and washing hands, however, it is perceived to be unpleasant when the water comes out of the tap while already foaming. The person taking a shower then gets the impression that he is washing himself with unclean water.

### OBJECT

As a result of this, the present invention has the object that the surfactants, which are contained in fecal-free domestic wastewater, are also removed as much as possible and that purified water is thus obtained, which is essentially surfactant-free and which at least does not foam when it is used for showering or for washing hands. The wastewater generated in a household is to further be recycled in the best possible way, in order to conserve water.

### DESCRIPTION OF THE INVENTION

This object is met by a system according to patent claim 1 and a method according to patent claim 11. Preferred embodiments are subject matter of the dependent claims.

The system according to the invention and the method according to the invention are provided for purifying fecal-free and surfactant-containing domestic wastewater. In the context of the present invention, the term “domestic wastewater” is understood to be wastewater from various sources, also referred to as consumers. The term does not only capture the classic private household, but in particular also a mobile household, for example in a camper, mobile home, or on a boat or ship, respectively. To an extended degree, this also includes wastewater from aircrafts and also from larger units, such as, for example, hotels, cruise ships, or entire residential complexes. However, industrial wastewater, as it results, for example, in manufacturing firms, is excluded from the definition.

The wastewater to be treated is fecal-free, i.e. black water, thus wastewater from the toilet, is excluded. It will typically be wastewater from the shower, from the bathtub, from the hand washbasin, from washing machines, thus grey water. It became clear, however, that wastewater from sinks and dishwashers can also be purified by means of the present invention, so that wastewater of this type is also included in the present definition. What is to be treated is thus wastewater from different consumers, provided that it is fecal-free wastewater.

It should be noted that with respect to some wastewater, the classification of wastewater as being so well recyclable that it can be used again for showering or bathing, can depend on the respective circumstances. Wastewater from the shower and from the bathtub generally only contains a small amount of surfactants and it generally likewise only carries a small dirt load. Wastewater from the sink and from the dishwasher generally contains a large amount of surfactants and grease, and generally contains relatively high dirt loads. Depending on the affected household and the use of surfactants taking place there as well as on the dirt load to be cleaned, wastewater from washing machines and hand washbasins can be purified into virtually pure clear water from time to time and can thus be used, e.g. as shower water, or it is to be qualified as dirtier wastewater, and consequently the purified clear water is to only be used, e.g., for flushing the toilet. As a result, an exact classification of the wastewater of a consumer depends on the actual circumstances.

As described above, it became clear that the electro-flotation alone was not sufficient to remove surfactants contained in the wastewater to be purified. After a large number of tests, the inventors were surprised to find that the introduction of a gas, in particular of air and/or of ozone, and in particular in fine-bubble form, in combination with the electrochemical treatment makes it possible to remove the contained surfactants to such an extent that the obtained clear water is largely free from surfactants, and at least does not foam when it leaves the shower head or the faucet.

Water is split during the electro-flotation. The oxygen created thereby rises as small gas bubbles and reacts with present pollutants in the liquid phase and/or accumulates at undissolved components, such as dirt particles. The floatation is made possible thereby. Due to the fact that gas is already created in the wastewater during the floatation and gas is thus already present in the wastewater, it could not be assumed that further introduction of gas could result in an improvement of the purification effect. Instead, it would have been necessary to assume that a different processing type is to be sought in order to completely remove surfactants. It came as a surprise, however, that the introduction of gas, regardless of whether prior to, during, or after the electro-flotation stage, greatly improves the surfactant purification, so greatly that virtually surfactant-free clear water is created. Neither electrochemical processing alone, nor the introduction of gas, and subsequent skimming of the foam alone, brought the desired success.

By means of the present invention, fecal-free and surfactant-containing domestic wastewater is transferred into sterile and odorless clear water, which is largely free from active washing substances. The fact that it can subsequently be used again, for example for showering, results in the advantage that sufficiently clean water for showering is in each case available for each person, which is an advantage that has an advantageous effect, in particular in the case of campers, mobile homes, and yachts, but also in hotels and cruise ships.

It is highly advantageous that total water quantities, which are to be transported, are reduced by means of the present invention. Due to the fact that a larger portion of the water circulates and is treated again, it is possible to reduce the fresh water quantity as well as the wastewater quantity. Fresh water tanks and wastewater tanks in mobile units can thus be dimensioned to be suitably smaller and/or the service life can be extended, without tedious refilling of the fresh water tank and/or emptying of the wastewater tank.

Due to the separate guidance and storage of dirty water from different sources, i.e. originating from different consumers, as well as clear water from different sources, the water, which is present in the system, is optimally usable and recyclable. Extremely dirty and surfactant-polluted water can be used to flush the toilet when purified; and not very dirty and surfactant-polluted water can be used for showering, washing hands, or doing dishes when purified. The fresh water consumption in a household can be greatly reduced in this way.

The system and the method can be operated in circulation, quasi “online”, i.e. while a person showers, the treatment of his/her shower water takes place, which is subsequently fed immediately to the shower again. An essentially “endless” shower time can be provided in this way with a small amount of shower water, e.g. with 10 liters of water.

In the alternative, the water is stored in a clear water container after the treatment and is then used during the next showering process. Until this next showering process has concluded, the dirty water thereof is collected in a dirty water container and is treated subsequently or at any point in time, e.g. at night, and is fed to the clear water container again. “Endless” shower times are obviously not possible in this way.

It goes without saying that the invention can also be used and is advantageous in stationary households, such as private households, residential complexes, and hotels. In many parts of the world and also in Europe, more ground water is consumed than is reproduced, so that it would be extremely desirable, if wastewater is recycled in larger quantities.

According to the invention, at least two dirty water containers and at least two clear water containers are present. Each of them stashes away wastewater and clear water, which originates from different consumers or which is intended for different consumers, respectively. The wastewater originating from the shower and/or bathtub and/or washing machine is thereby collected in the one dirty water container, and the dirty water originating from the hand washbasin and/or the sink and/or dishwasher is collected in the other dirty water container. Wastewater from the hand washbasin, the sink, and the dishwasher is typically dirtier and often also contains a much larger quantity of surfactants than shower or bath water and optionally washing machine water. These types of wastewater are thus kept separate and are purified separately, because shower and bath water can be treated more easily, and can thus be treated to a higher purity than the wastewater from the sink, etc. Different types of wastewater originating from different consumers, can be stored separately, purified separately, and used again separately, and with the largest possibly flexibility by means of the present system, depending on the level of soiling thereof and the type of soiling thereof.

If the household requires it, more than two dirty water tanks and/or more than two clear water tanks can also be provided. On large ships or at camping sites, for example, it can be advantageous when, e.g., three types of dirty water tanks are present, one for dirty water from the showers, a second one for dirty water from the sinks, and a third one for dirty water from the hand washbasins and washing machines. Depending on the level of soiling, e.g. of the wastewater in the third dirty water container (dirty water from the hand washbasin), the clear water resulting after passing through the purification stages can be fed into the shower water-clear water container for showering, or into the toilet flushing water-clear water container.

According to the invention, bath and shower wastewater is also collected in a separate clear water container after the purification, and the dirtier wastewater from the sink, etc. in a further separate clear water container after the purification. Water from the second clear water container, i.e. purified shower and bath water, can then be used to shower and bathe again, whereas in contrast, the clear water from the first clear water container, i.e. purified handwashing water, dishwashing water, and dishwashing machine wastewater is preferably used to flush the toilet.

The introduction of gas can take place, for example, with the help of a compressor, a pump, a stirrer, or, particularly preferably, by means of an aeration membrane, also referred to as venting membrane, in particular by means of a ceramic aeration membrane. It became clear that it is particularly advantageous when the gas is as fine-bubbled as possible, in order to provide the largest possible surface. Fine-bubble gas bubbles generated by means of ceramic aeration membranes have a diameter of, for example, approx. 50-100 μm.

A further improvement in the surfactant removal is attained in that in a preferred design, a calming zone or several calming zones, in which the purified water can calm to the extent that it can be discharged, exist within the electrochemical processing unit or immediately adjacent thereto. During the calming, small gas bubbles, which may still be present, originating from the electro-flotation as well as introduced in the form of fine bubbles, will rise to the top, and will thus entrain surfactants or pollutants, which may still be present. The calming zone is thus arranged in the floor area of the electro-flotation system and is separated via a separation.

The separated, i.e. floated foam, which is loaded with surfactants, possibly present harmful substances and dirt particles, is processed as wastewater and is fed to a wastewater tank or is discarded immediately, respectively. In a camper, for example, it could be processed like black water originating from the toilet and could be fed to a common wastewater tank.

The discharging of the floatable water constituents into the wastewater tank takes place, e.g., via an overflow pipe. The latter can simultaneously also serve as forced venting or can have such a forced venting, respectively, in order to guide the released hydrogen from the electro-flotation and the foam to the outside.

Prior to the introduction into the wastewater tank, the foam can be destroyed, in order to bring about a volume reduction. The destruction of the foam can take place, for example, by means of sonicating, by means of chemical anti-foaming agents, by means of mechanical methods, such as the guiding through a foam-destroying woven fabric or screen, by washing away or showering down by means of a corresponding liquid. This foam-destroying system is preferably mounted in the overflow pipe.

In the case of the system according to the invention, further pre-treatment and post-treatment stages can be added, such as, for example, various filtration stages. Typically, both a pre-processing will be performed by means of a pre-filter or coarse filter, and a post-processing will be performed by a post-filter. The pre-filter or coarse filter thereby predominantly filters out coarser particles; the post-filter generally serves to separate fines, which may still be present. Sand filters, microfiltration, nanofiltration, ultrafiltration, and reverse osmosis are thus preferably used as post-processing filtration units. For example screens and woven fabrics are possible as pre-filter and coarse filter.

In one embodiment, the clear water generated by means of the method according to the invention or the system according to the invention, respectively, which can also be referred to as industrial water, can also be used for backflushing the filtration system.

The fresh water container, i.e. the container in which water originating from communal water supply systems is stashed away, can be kept relatively small by means of the system according to the invention, and even more so by means of the system in the preferred embodiments. The predominant portion of the water supply, for example of a camper or of a yacht, can thus be covered via recycled water. One of the main problems when traveling for example on a yacht, the timely stashing away of water, is significantly simplified thereby. The yacht can thus travel much longer, without having to add water again, than if it did not have a recycling system according to the invention on board.

Moreover, a water shortage in the clear water tank, e.g. in an aircraft, can be capable of being detected via a sensor system, so that, for example via an electronic controller, a subsequent washing process in the hand washbasin in the lavatory can be lengthened, until this water shortage is fixed. For all intents and purposes, more dirty water and thus clear water is thus intentionally generated by increased consumption of fresh water.

Moreover, a grey water feed and the electro-flotation device can be connected to one another on the floor side according to the principle of the communicating tubes. According to an exemplary embodiment, the electro-flotation device and the filtration stage are connected on the surface side according to the overflow principle. From the dirty water container, the polluted water flows into the cleaning, i.e. into the pre-filter, if present, or directly into the electro-flotation stage, according to the principle of the communicating tubes.

The layer thickness of the generated and removed foam, i.e. the floated, can take place, for example, by means of an optical measurement, for example in the form of a light barrier or in the form of an ultrasonic measurement.

To avoid that an aluminum or iron hydroxide layer attaches to the anodic plates, the polarity thereof is reversed within certain time intervals.

The filling level of the liquid containers—dirty water containers, clear water containers, fresh water containers, wastewater containers—is preferably monitored, e.g. via a float gauge or via a different fill level sensor. For example when reaching a fill maximum in the clear water tank for feeding into the shower, a float valve can thus be opened by means of a corresponding float gauge, which floats upwards, wherein the excess liquid is either transferred into a clear water tank, more precisely into the clear water tank for flushing the toilet, or is fed to the wastewater container.

### BRIEF DESCRIPTION OF THE FIGURES

The invention will be explained and described in more detail below on the basis of the enclosed drawing, in which:

FIG. 1 shows a first exemplary embodiment of a domestic wastewater recycling system according to the invention, and

FIG. 2 shows a second exemplary embodiment of a domestic wastewater recycling system according to the invention.

### DESCRIPTION OF THE FIGURES

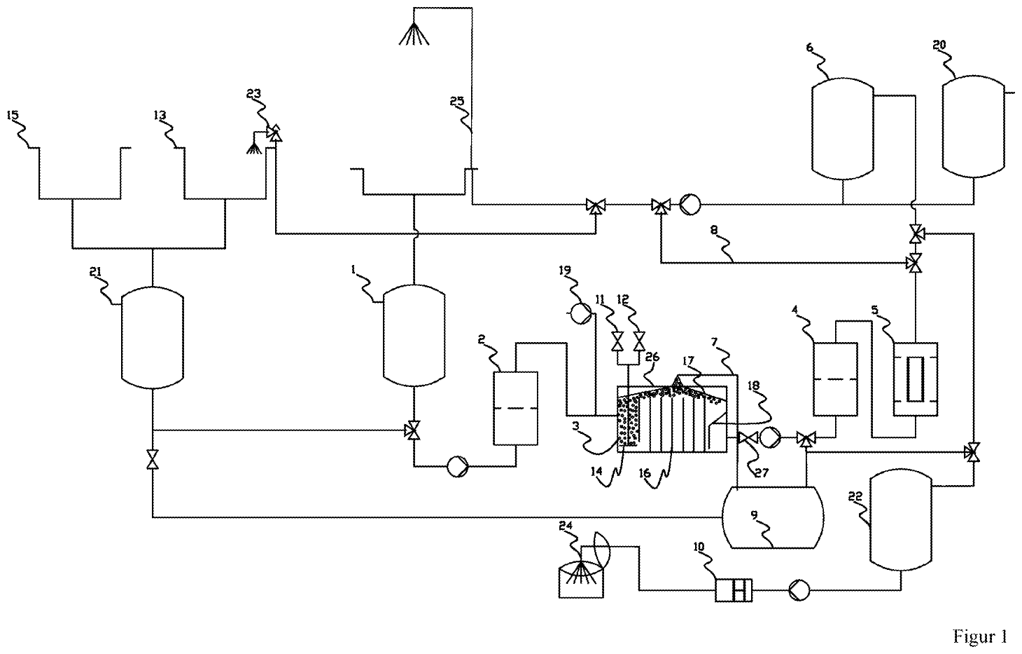

FIG. 1 shows a wastewater purification system, which could be realized, for example, in a camper or a yacht. Two dirty water containers are present, one shower dirty water tank 1, and one general dirty water tank 21. Wastewater from the shower 25 reaches into the shower dirty water tank 1. Wastewater from a washbasin 15 and from a sink 13 are fed to the dirty water tank 21.

The dirty water from the two dirty water containers 1 and 21 can be fed to a pre-filter 2. The wastewater from the two dirty water containers 1 and 21 can thereby be fed to the pre-filter 2 in a combined manner or can be kept separate and can in each case be guided separately through the purification stages. Coarser dirt particles and other coarser substances in the wastewater, such as, e.g., hair, are separated in the pre-filter 2.

After the wastewater has passed through the pre-filter 2, it is fed to an electrochemical processing unit 3. On the way there, chemicals can also be added, if necessary, such as, for example, chemicals for the water treatment and splitting agents. The adding unit for chemicals is identified with reference numeral 19.

In the embodiment of FIG. 1, the electrochemical processing unit 3 is equipped with plate electrodes 16. The plate electrodes are aligned parallel to one another.

In the electrochemical processing unit 3, gas in the form of fine bubbles is introduced via a venting membrane 14. For example ozone from an ozone ventilation 11 can be used as gas. Ozone is a strong oxidizing agent, so that germs, which may be contained, are killed. For example iron, manganese, and organic substance is furthermore oxidized thereby. In the alternative or simultaneously, air can be used as gas for the introduction of gas, identified by reference numeral 12.

As can be seen, the unit for introducing gas is arranged within the electrochemical processing unit 3, namely the venting membrane 14, in the preferred embodiment. It is also possible, however, that the air is introduced in the form of fine bubbles in the pipe system, which leads directly into the electrochemical processing unit, i.e. between adding unit for chemicals 19 and electrochemical processing unit 3, or upstream of the adding unit for chemicals 19 in the feed pipe.

Foam is created in the electrochemical processing unit 3, both by means of the electro-flotation itself, and by means of the fine gas bubbles, as suggested in FIG. 1. The foam is compressed via a foam compression 17 and is discharged via an overflow pipe 7 and is fed to a wastewater tank 9.

A calming zone 18, in which the water is collected prior to the discharge from the electrochemical processing unit and can calm, so that gas, which may still be contained, escapes, and foam rises to the top, is likewise entered in FIG. 1. The calming zone 18 is separated from the remaining interior of the electrochemical processing unit 3 via a separation. Water thus enters into this calming zone 18 from the bottom, very close to the floor of the electrochemical processing unit 3.

An automatic level raise 27 serves for and improves the foam discharge.

Water purified in the electrochemical processing unit is finally fed to a fine filter 4, for example a sand filter, or to a microfiltration unit, and to an activated carbon filter 5. The purified water is finally fed to one of the two clear water containers or to both of them, namely to the clear water tank 6 or to the toilet clear water tank 22. For example, the shower 25 is fed from the clear water tank 6, or also a separate faucet 23 of the sink 13, in order to pre-clean dishes, for example. Water from the toilet clear water tank 22 is fed to the toilet flusher 24 with the help of a pressure cylinder 10.

It can be seen that the two dirty water containers 1 and 21 as well as the two clear water containers 6 and 22 can be processed separately. For example, the dirty water from the shower dirty water tank 1 can thus be guided through the purification stages and can be fed to the clear water tank 6 or to the toilet clear water tank 22. The same applies for wastewater from the second dirty water tank 22.

If necessary, fresh water can be used directly from a fresh water tank 20, for example also for showering or for doing dishes. If necessary, the clear water tanks 6 and 22 can furthermore also be replenished by fresh water from the fresh water tank 20.

Filtration systems can preferably be backflushed, in order to remove residues adhering during the filtration process, and in order to thus reestablish the filtration pipe. A backflushing pipe 8 is provided for this purpose, so that treated clear water can be used for backflushing, for example for backflushing the activated carbon filter 5. In the alternative, fresh water from the fresh water tank 20 can also be used for backflushing.

Foam from the overflow pipe 7 is collected in the wastewater tank 9. Wastewater collected in the dirty water tank 21, i.e. sink wastewater and hand washbasin wastewater, can furthermore also be transferred directly into the wastewater tank 9, when, for example, heavy dirt loads are contained temporarily.

In a preferred embodiment, a showering process has two parts. First of all, water from the clear water tank 6 is used for showering, i.e. the body is moistened. After lathering, water from the clear water tank 6 is still used to rinse off the soap, and fresh water from the fresh water tank 22 is subsequently used to rinse again.

The toilet flusher 24 preferably has fine nozzles. It is supplied with clear water from the toilet clear water tank 22 with the help of a pressure cylinder 10, in particular by means of a high-pressure cylinder or by means of a water pump.

The electrochemical processing unit 3 comprises a direct current voltage source, the polarity of which can be reversed. The polarity of said direct current voltage source can be reversed in a time- or state-controlled manner, in order to prevent an attachment of hydroxides to the electrodes 16. A reversal of the polarity also serves the purpose of ensuring an even wear of the electrodes 16, thus of anodes and cathodes.

The electrochemical processing unit 3 is encapsulated in the upper region, i.e. provided with a cover 26.

The electro-flotation stage can also comprise oxidizing agents, by means of which free hydrogen molecules within the wastewater treatment are oxidized into water. It is also possible to use atmospheric oxygen to convert the released hydrogen via a catalytic converter into water, wherein the atmospheric oxygen reaches into the system via a ventilation, e.g. via the overflow pipe.

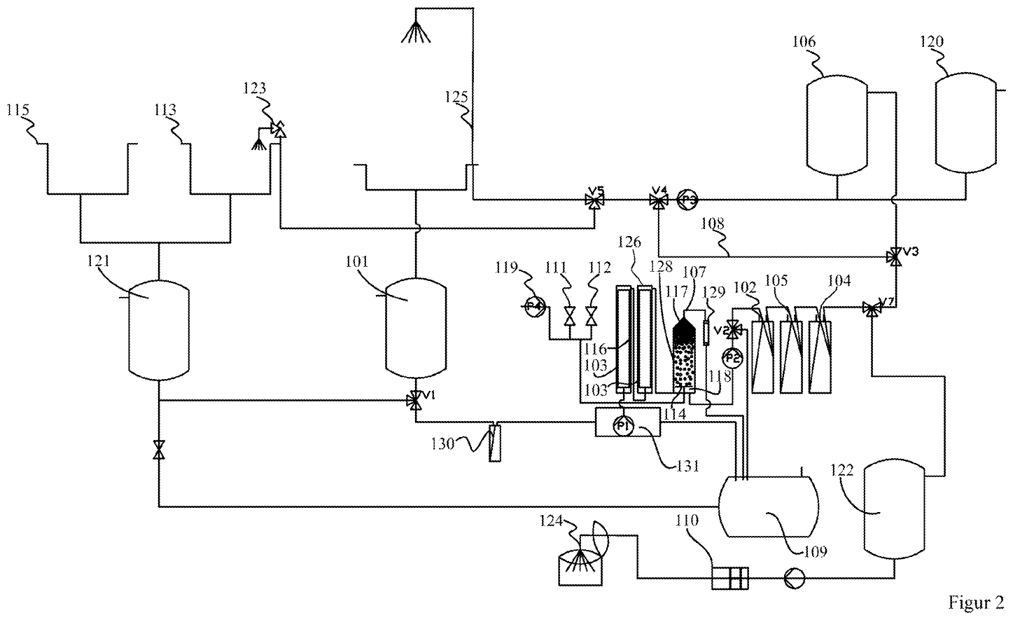

An alternative embodiment of a domestic wastewater purification system is illustrated schematically in FIG. 2.

Two dirty water tanks are present—a first dirty water tank 121, in which wastewater from a washbasin 115 and a sink 113 is collected, and a second dirty water tank 101, also referred to as shower dirty water tank, in which wastewater from the shower 125 is collected.

Yet a further wastewater tank is provided, the wastewater tank 109, in which the wastewater to be discarded is collected, e.g. toilet wastewater. Wastewater from the first dirty water tank 121 can be purified as well as discarded. In the latter case, it is fed to the wastewater tank 109.

Wastewater to be purified, e.g. from the second dirty water tank 101, is initially guided via a coarse filter 130. There, coarse pollutants, such as sand or hair, are removed. With the help of a pump P1, it subsequently reaches into the electrochemical processing unit 103, where the electro-flotation is performed.

The pump P1 is arranged in a container 131. The dirty water is temporarily stored therein and is fed to the first one of the two tubular electrochemical processing units 103 by means of the pump P1. The container 131 has a buffer function. If the system is turned off, too much dirty water arrives, or if the system produces too little power, this buffer flows over and dirt water reaches directly into the wastewater tank 109 without processing. For example in the case of failures in the system, it can thus be ensured that showering can continue without interferences.

In the embodiment of FIG. 2, tube assemblies are used as electrochemical processing units 103, which are in each case covered by means of a cover 126. Tubular electrodes 116 have the advantage that, compared to plate electrodes, they have a smaller space requirement with the same reaction surface, which is an advantage, which becomes noticeable in particular in the case of campers, mobile homes, aircrafts, or yachts. In the embodiment of FIG. 2, two tube assemblies are connected in series.

After passing through the electrochemical processing unit, the wastewater to be treated reaches into a relaxation container 128. A relaxation floatation is performed there. For this purpose, gas is introduced via a venting membrane 114. In the present case, ozone can be introduced via an ozone ventilation 111 and air can be introduced via a unit for introducing air 112. Ozone and air can in each case be introduced separately as well as combined. Which gas is to be used depends on the wastewater, which is to be treated, and can be easily determined by the expert by means of simple tests.

Chemicals can also be added in the relaxation container with the help of the adding unit for chemicals 119, if required.

During the relaxation floatation in the relaxation container 128, components of the wastewater, e.g. surfactants, which are precipitated in the electro-flotation or which are bound to small oxygen or hydrogen bubbles, which are generated, e.g. during the electro-flotation, are enriched and are collected via a foam compression 117. Flocks and particles carrying dirt loads accumulate in this way in the upper region of the container 128, because the flocks and particles rise up due to the attachment of gas bubbles in the water. Purified clear water thus remains in the lower region of the container, below the venting membrane 114, referred to as calming zone 118. The collected foam is removed via an overflow pipe 107 and is guided through a foam destroyer 129. The foam is destroyed there, e.g. by means of sonication or with the help of chemicals. The separated portion of the purified dirty water subsequently reaches into the wastewater tank 109.

In the present embodiment, the purified water, which is removed in the lower region of the relaxation container 128, is finally guided past three filtration systems, where the water is further purified. The individual filtration stages become increasingly finer thereby. First of all, the water purified in the two floatation stages reaches into a pre-filter 102, then into an activated carbon filter 105, and finally into a fine filter 104.

Instead of the further purification, the water, which was thoroughly purified in the two floatation stages, can also be discharged, in that it is pumped into the wastewater tank 109 via a corresponding valve, here V2, with the help of a pump P2.

The clear water, which has run through all purification stages, is either fed to the toilet clear water tank 122 after the last purification stage or is fed directly to the shower system—either in that it is stashed away in a clear water tank 106 or in that it is fed directly to the shower 125. Corresponding valves V7, V3, V4, and V5 ensure the desired feed.

A separate faucet 123, to which clear water purified in the system can be fed, is further provided at the sink 113. Recycled water can thus be used, e.g. for pre-rinsing dishes, cutlery, and pots, or it can be used as water for cleaning.

Water stashed away in the toilet clear water tank 122 is used to flush the toilet 124. In mobile systems, a pressure cylinder 110 is provided for this purpose, which sprays the water in the toilet 124 while saving water.

A fresh water tank 120 is furthermore also provided. If not enough recycled clear water is present or, e.g. when concluding a showering process, fresh water from the fresh water tank 120 can be fed to the shower 125.

Fresh water from the fresh water tank 120 or clear water from the clear water tank 106 can be used via a backflushing pipe 108, in order to backflush the system, in particular the three filtration stages 102, 104, and 105.

According to the invention, two dirty water tanks are present, provided with reference numerals 121 and 101. This makes it possible that different types of wastewater can be kept separate and can be treated separately. Two clear water tanks, reference numerals 106 and 122, are furthermore also present, whereby clear water of different origins can be kept separate and can be used separately. In a preferred embodiment, wastewater from the hand washbasin 115 and sink 113 is stored in the dirty water tank 121. After the treatment thereof with the help of the above-described system, the resulting clear water is typically stored in the toilet clear water tank 122 and will be used to flush the toilet 124. Wastewater from the sink and from the hand washbasin is possibly not completely clean, even after passing through all purification stages, so that it is unsuitable for showering or bathing. The same also applies, for example, for wastewater from the dishwasher. The situation is different for wastewater from the shower, collected in the dirty water tank 101. These types of wastewater can be treated well in this way because they are relatively lightly contaminated, so that they can subsequently be used again for showering. Shower wastewater, which has passed through the system, is thus collected in the clear water tank 106 and is then fed to the shower 125 again, or it is fed directly to the shower 125. The above also applies for bath water, which is generally dirty only very slightly.

Some valves and pumps are also entered in the schematic illustration, and are accordingly identified as P1, P2, etc., and V1, V2, etc.

An even larger independence on communal systems results in that in a further preferred embodiment, which is not graphically presented, however, sea or river water can be drawn in and can be guided through the wastewater purification. For example, a further separate dirty water container would be provided for this purpose. Rain water can also be treated in this way and can be used as industrial water, for example for showering or for flushing the toilet.

List of Reference Numerals

| Reference Numeral | name |
|---|---|
| 1, 101 | shower dirty water tank |
| 2, 102 | pre-filter |
| 3, 103 | electrochemical processing unit |
| 4, 104 | fine filter |
| 5, 105 | activated carbon filter |
| 6, 106 | clear water tank |
| 7, 107 | overflow pipe |
| 8, 108 | backflushing pipe |
| 9, 109 | wastewater tank |
| 10, 110 | pressure cylinder |
| 11, 111 | ozone ventilation |
| 12, 112 | unit for introducing air |
| 13, 113 | sink |
| 14, 114 | venting membrane |
| 15, 115 | washbasin |
| 16, 116 | electrodes |
| 17, 117 | foam compression |
| 18, 118 | calming zone |
| 19, 119 | adding unit for chemicals |
| 20, 120 | fresh water tank |
| 21, 121 | dirty water tank |
| 22, 122 | toilet clear water tank |
| 23, 123 | separate faucet |
| 24, 124 | toilet flusher |
| 25, 125 | shower |
| 26, 126 | cover |
| 27 | level raise |
| 128 | relaxation container |
| 129 | foam destroyer |
| 130 | coarse filter |
| 131 | container |

What is claimed is:

1. A system for purifying fecal-free and surfactant-containing domestic wastewater, in particular grey water and kitchen wastewater, in particular for installation in a mobile living unit, such as a mobile home or a camper, or in a watercraft, wherein the system has an electrochemical processing unit and a device for introducing gas, in particular air and/or ozone, wherein the system comprises the following:
at least one dirty water container, in which the domestic wastewater to be purified is collected;
at least one wastewater tank, in which components of the domestic wastewater, which are to be discarded, are collected;
at least one clear water container, in which the purified domestic wastewater is collected, and
pipes, which interconnect the above-mentioned,
wherein at least two dirty water containers are present, wherein domestic wastewater to be purified from at least one first consumer, such as a sink, a hand washbasin, and/or a dishwashing machine, can be fed to a first dirty water container, and wherein domestic wastewater to be purified from at least one second consumer, such as a shower, a bathtub and/or a washing machine, can be fed to a second dirty water container, and that at least two clear water containers are present, wherein the domestic wastewater, which originates from the first dirty water container and which is purified, can be fed to a first clear water container, and wherein the domestic wastewater, which originates from the second dirty water container and which is purified, can be fed to a second clear water container.

2. The system according to patent claim 1,
wherein the device for introducing gas is arranged upstream of or within the electrochemical processing unit.

3. The system according to patent claim 2,
wherein the electrochemical processing unit has an overflow, via which foam can be discharged from the electrochemical processing unit, and foam resulting from the introduction of gas.

4. The system according to patent claim 1,
wherein the device for introducing gas is arranged downstream from the electrochemical processing unit.

5. The system according to patent claim 1,
wherein the device for introducing gas has a venting membrane, in particular a ceramic venting membrane.

6. The system according to patent claim 1,
wherein a calming zone, through which electrochemically processed domestic wastewater can be guided prior to a discharging through a clear water drain, is arranged within the electrochemical processing unit or adjacent to the latter, wherein in particular the calming zone is located in a region of the electrochemical processing unit close to the floor, so that foam, which is present therein, does not reach into the clear water drain.

7. The system according to patent claim 1,
wherein at least one of the following filtration units is present: a coarse filter, a pre-filter, a post-processing filter, in particular a fine filter, an activated carbon filter.

8. The system according to patent claim 7,
wherein a means for backflushing the coarse filter, the pre-filter and/or the post-processing filter and/or the activated carbon filter is present, wherein in particular treated clear water from the second clear water tank can be used for the backflushing.

9. The system according to patent claim 1,
wherein a plate-type reactor or a tubular reactor are provided as electrochemical processing unit.

10. The system according to patent claim 1,
wherein the first clear water container is connected to a flusher of the toilet, and that the second clear water container is connected to the shower, the hand washbasin, the washing machine and/or the sink.

11. A method for purifying fecal-free and surfactant-containing domestic wastewater, in particular grey water and kitchen wastewater,
wherein the domestic wastewater is fed to an electrochemical processing stage, and wherein a gas, in particular air and/or ozone, is introduced into the domestic wastewater to be purified, so that the contained surfactants are foamed and separated,
wherein the domestic wastewater to be purified is processed separately,
in that at least two dirty water containers are present, wherein domestic wastewater to be purified from at least one first consumer, such as a sink, a hand washbasin and/or a dishwashing machine, is fed to a first dirty water container, and wherein domestic wastewater to be purified from at least one second consumer, such as a shower, a bathtub and/or a washing machine is fed to a second dirty water container, and in that two clear water containers are present, wherein the domestic wastewater, which originates from the first dirty water container and which is purified, is fed to a first clear water container, and wherein the domestic wastewater, which originates from the second dirty water container and which is purified, is fed to a second clear water container.

12. The method according to patent claim 11,
wherein foam and hydrogen resulting during the electrochemical processing stage are discharged via an overflow pipe, wherein the foam is in particular guided into a wastewater tank.

13. The method according to patent claim 12,
wherein the resulting foam is destroyed prior to introduction into the wastewater tank, in particular by means of sonicating, with the help of a foam-destroying chemical, by means of guide-through through a foam-destroying woven fabric and/or by means of showering down by means of a liquid, wherein the destruction of the foam preferably takes place in the overflow pipe.

14. The method according to of patent claim 11,
wherein the gas is introduced with the help of a compressor, a pump, a venting membrane, a stirrer, or a ceramic membrane, wherein in particular a fine-bubble gas is generated and introduced.

15. The method according to patent claim 11,
wherein the gas is introduced within the electrochemical processing stage via a venting membrane located there, in particular a ceramic venting membrane.

16. The method according to patent claim 11,
wherein the gas is introduced following the electrochemical processing stage in a relaxation container.

17. The method according to patent claim 11,
wherein oxidizing agents are fed to the electrochemical processing stage.

18. The method according to patent claim 11,
wherein the domestic wastewater treated by means of the electrochemical processing stage is guided via an activated carbon filter and/or another post-processing unit, such as, e.g., a fine filter, prior to the introduction into a clear water tank and/or prior to the renewed use, in particular for showering or for flushing a toilet, and is further purified, wherein it is in particular at least one of the following filter units: a sand filter, a microfiltration unit, a unit for nanofiltration, a unit for ultrafiltration, and a reverse osmosis unit.

19. The method according to patent claim 18,
wherein the domestic wastewater is guided through a pre-filter or through a coarse filter, in particular for separating larger particles, such as dirt particles and hair, prior to the introduction into the electrochemical processing stage and/or prior to the introduction of gas.

20. The method according to patent claim 11,
wherein chemicals for the water treatment and splitting agents are added, in particular prior to entry into the electrochemical processing stage or prior to entry into the relaxation container.

21. The method according to patent claim 19,
wherein the activated carbon filter, the post-processing filter unit, the coarse filter and/or the pre-filter are backflushed, in particular by using the purified domestic wastewater.

22. The method according to patent claim 11,
wherein clear water from the first clear water container is provided for flushing a toilet whereas clear water from the second clear water container is provided for showering, washing hands, cleaning laundry, and/or doing dishes.

23. The method according to patent claim 11,
wherein the electrochemical processing stage comprises a direct current voltage source, the polarity of which can be reversed, and the polarity of which can be reversed in a time and/or state-controlled manner, in order to prevent attachments to cathodes and/or anodes of the electrochemical processing stage and/or to attain an even wear of the cathodes and/or anodes.
